(19) United States
(12) Patent Application Publication
(10) Pub. No.: US 2025/0157679 A1
(43) Pub. Date: May 15, 2025

(54) NUCLEAR REACTOR SHUTDOWN SYSTEM AND METHOD OF NUCLEAR REACTOR SHUTDOWN

(71) Applicant: MITSUBISHI HEAVY INDUSTRIES, LTD., Tokyo (JP)

(72) Inventors: Shohei Otsuki, Tokyo (JP); Satoru Kamohara, Tokyo (JP); Tadakatsu Yodo, Tokyo (JP); Shota Kobayashi, Tokyo (JP); Nozomu Murakami, Tokyo (JP); Wataru Nakazato, Tokyo (JP); Keisuke Sano, Tokyo (JP); Daisuke Fujiwara, Tokyo (JP); Hirokazu Sugiura, Tokyo (JP); Yutaka Tanaka, Tokyo (JP); Tatsuo Ishiguro, Tokyo (JP); Hironori Noguchi, Tokyo (JP); Tsuyoshi Tokairin, Tokyo (JP); Takanori Karato, Tokyo (JP); Takahiro Miyamoto, Tokyo (JP)

(73) Assignee: MITSUBISHI HEAVY INDUSTRIES, LTD., Tokyo (JP)

(21) Appl. No.: 18/839,891

(22) PCT Filed: Feb. 15, 2023
(86) PCT No.: PCT/JP2023/005137

§ 371 Date: Aug. 20, 2024

(30) Foreign Application Priority Data
Mar. 3, 2022 (JP) 2022-032593

(51) Int. Cl. G21C 9/027; G21C 7/14

(52) U.S. Cl. CPC G21C 9/027; G21C 7/14

(57) ABSTRACT

A nuclear reactor shutdown system includes a shielded path that passes through a reactor core fuel housed in a nuclear reactor vessel in a hermetically sealed manner, one end of the shielded path having an opening and another end of the shielded path being closed; a neutron absorber that is allowed to enter from the opening of the shielded path; an elastic member that is configured to urge the neutron absorber in a direction entering inside from the opening of the shielded path by being released from a compressed state; and a braking part that is disposed so as to maintain the compressed state of the elastic member and is configured to release the elastic member from the compressed state when the braking part reaches or exceeds a threshold temperature.

### FIELD

The present disclosure relates to a nuclear reactor shutdown system and a method of nuclear reactor shutdown.

### BACKGROUND

In a nuclear power generation system using a nuclear fuel and utilizing heat from a nuclear reaction to generate electricity, heat generated in a nuclear reactor is recovered by a primary cooling system in which a primary coolant circulates between the nuclear reactor and a secondary cooling system, heat exchange is performed between the primary coolant and a secondary coolant, and a turbine provided in the secondary cooling system is rotated by the energy of the secondary coolant, thus generating electricity. Such nuclear facilities include a system for termination of the nuclear reaction in the nuclear reactor in an emergency. For example, Patent Literature 1 discloses a fuel assembly including a control element pin including a neutron absorber fixed at the top by a stopper melting when reactor output increases. In nuclear reactors including such a fuel assembly, the stopper melts when the reactor output increases, causing the neutron absorber to fall into a fuel part to shut down the nuclear reactor.

### CITATION LIST

### Patent Literature

Patent Literature 1: Japanese Patent Application Laid-open No. S62-47585

### SUMMARY

### Technical Problem

In recent years, facilities using relatively small-sized nuclear reactors have been considered as power generation facilities and the like using nuclear reactors. For example, a micro reactor has been developed that does not have the primary cooling system in which the primary coolant circulates but has a heat conduction part conducting heat in a nuclear reactor vessel to the outside through solid-state heat conduction. When such a small-sized nuclear reactor is used, it may be difficult to use conventional nuclear reactor shutdown systems without modification.

The present disclosure solves the problem described above, and an object thereof is to provide a nuclear reactor shutdown system and a method of nuclear reactor shutdown for reactor scram that can be used for small-sized nuclear reactors while maintaining safety and quickness.

### Solution to Problem

To achieve the above-described object, a nuclear reactor shutdown system according to one aspect of the present disclosure includes: a shielded path that passes through a reactor core fuel housed in a nuclear reactor vessel in a hermetically sealed manner, one end of the shielded path having an opening and another end of the shielded path being closed; a neutron absorber that is allowed to enter from the opening of the shielded path; an elastic member that is configured to urge the neutron absorber in a direction entering inside from the opening of the shielded path by being released from a compressed state; and a braking part that is disposed so as to maintain the compressed state of the elastic member and is configured to release the elastic member from the compressed state when the braking part reaches or exceeds a threshold temperature.

To achieve the above-described object, a method of nuclear reactor shutdown is for: a shielded path that passes through a reactor core fuel housed in a nuclear reactor vessel in a hermetically sealed manner, one end of the shielded path having an opening and another end of the shielded path being closed; a neutron absorber that is allowed to enter from the opening of the shielded path; an elastic member that is configured to urge the neutron absorber in a direction entering inside from the opening of the shielded path by being released from a compressed state; and a braking part that is disposed so as to maintain the compressed state of the elastic member and is configured to release the elastic member from the compressed state when the braking part reaches or exceeds a threshold temperature, and includes causing the neutron absorber urged by the elastic member to enter inside from the opening of the shielded path by releasing the elastic member from the compressed state when the braking part reaches or exceeds the threshold temperature.

### Advantageous Effects of Invention

The present disclosure can produce an effect of being capable of being used for small-sized nuclear reactors while maintaining safety and quickness.

### BRIEF DESCRIPTION OF DRAWINGS

FIG. 1 is a schematic diagram of a schematic configuration of a nuclear power generation system according to the present embodiment.

FIG. 2 is a schematic diagram of a schematic configuration of a nuclear reactor unit including a nuclear reactor shutdown system according to the present embodiment.

FIG. 3 is a schematic diagram of a state in which the nuclear reactor shutdown system illustrated in FIG. 2 has worked.

FIG. 4 is a schematic diagram of a nuclear reactor unit including another example of the nuclear reactor shutdown system.

FIG. 5 is a schematic diagram of a state in which the nuclear reactor shutdown system illustrated in FIG. 4 has worked.

FIG. 6 is a schematic diagram of a nuclear reactor unit including another example of the nuclear reactor shutdown system.

### DESCRIPTION OF EMBODIMENTS

### Embodiment

The following describes an embodiment according to the present disclosure in detail based on the accompanying drawings. This invention is not limited by this embodiment. In addition, the components in the following embodiment include ones that those skilled in the art can replace and easy, substantially the same ones, and ones within the range of equivalence. Furthermore, the components in the following embodiment can be omitted, replaced, or changed in various ways to the extent not departing from the gist of the present disclosure. In the following embodiment, the components that are necessary to exemplify the embodiment are described, other components are omitted, the same components are denoted by the same symbols, and different components are denoted by different symbols.

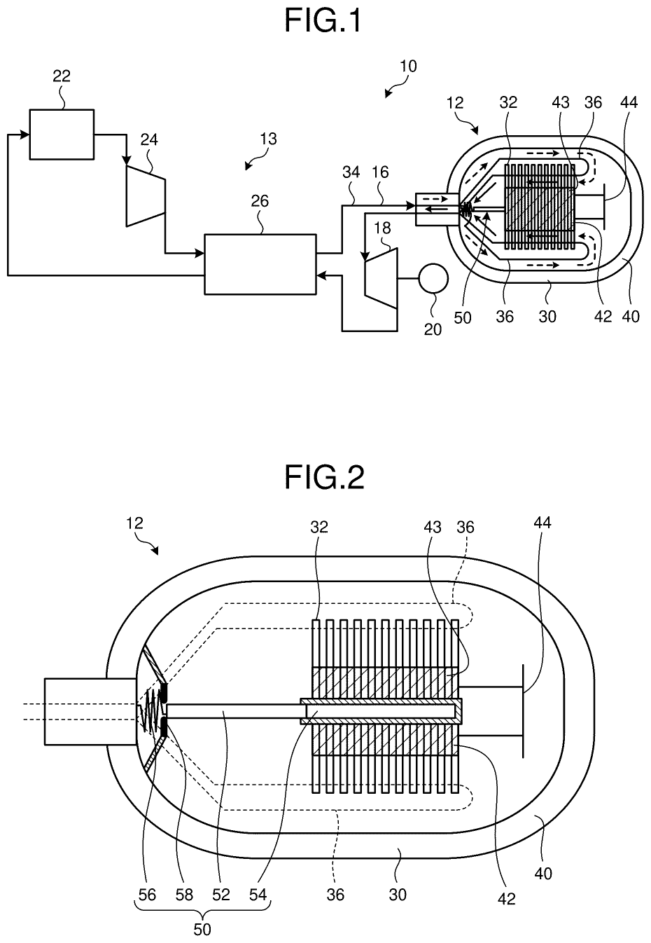

FIG. 1 is a schematic diagram of a schematic configuration of a nuclear power generation system according to the present embodiment. This nuclear power facility illustrated in FIG. 1 is described as a case of nuclear power generation generating electricity using heat generated by a nuclear reactor, but the present disclosure is not limited to this case. It can also be used for facilities using the heat generated by the nuclear reactor for purposes other than power generation. In addition, it can also be used as a facility producing radioactive materials using radiation generated by the nuclear reactor. This nuclear power generation system 10 illustrated in FIG. 1 includes a nuclear reactor unit 12 and a power generation unit 13. The power generation unit 13 has a coolant circulation unit 16, a turbine 18, a generator 20, a cooler 22, a compressor 24, and a regenerative heat exchanger 26.

The nuclear reactor unit 12 has a nuclear reactor 30, a heat conduction part 32, and a nuclear reactor shutdown system 50. The nuclear reactor 30 has a nuclear reactor vessel 40, a reactor core fuel 42, and a control unit 44. The nuclear reactor vessel 40 houses the reactor core fuel 42 inside. The nuclear reactor vessel 40 houses the reactor core fuel 42 in a hermetically sealed manner. The nuclear reactor vessel 40 is provided with an opening-and-closing part to allow insertion and removal of the reactor core fuel 42 to be placed inside. The opening-and-closing part is, for example, a lid. The nuclear reactor vessel 40 can remain the hermetically sealed state even when a nuclear reaction occurs inside and the inside reaches a high temperature and a high pressure. The nuclear reactor vessel 40 is formed of a material having blocking performance for neutron rays and is formed thick enough to prevent neutron rays generated inside from leaking to the outside. The nuclear reactor vessel 40 is formed of, for example, concrete. The nuclear reactor vessel 40 may contain an element having highly blocking performance, such as boron.

The reactor core fuel 42 includes a plurality of fuel holding plates 43. The fuel holding plates 43 have a plurality of nuclear fuels placed inside. The fuel holding plates 43 are formed of a material conducting heat generated by the nuclear fuels. Graphite, silicon carbide, or the like can be used for the fuel holding plates 43. The reactor core fuel 42 produces reaction heat as the nuclear fuel undergoes a nuclear reaction.

The control unit 44 has a blocking member movable through the reactor core fuel 42. The blocking member is what is called a control rod including functions of blocking radiation and inhibiting a nuclear reaction. The nuclear reactor 30 controls the reaction of the reactor core fuel 42 by moving control unit 44 and adjusting the position of the blocking member.

As illustrated in FIG. 1, the heat conduction part 32 is disposed inside the nuclear reactor vessel 40 and is in contact with the fuel holding plates 43. The heat conduction part 32 of the present embodiment has a plurality of plates and has a structure in which they are alternately stacked with the fuel holding plates 43. The heat conduction part 32 has plates larger in external shape than the fuel holding plates 43 and protrudes into the area in which the fuel holding plates 43 are not disposed. Here, for the heat conduction part 32, for example, titanium, nickel, copper, graphite, or graphene can be used.

For the heat conduction part 32, graphene arranged in an orientation facilitating heat conduction in a direction along the surface of the plate is preferably used in order to increase the efficiency of heat conduction to the protruding parts. The heat conduction part 32 conducts heat through solid-state heat conduction. That is, the heat conduction part 32 conducts heat without using a heat medium (fluid). Specifically, the heat conduction part 32 conducts heat generated by the reactor core fuel 42 to the power generation unit 13 through solid-state heat conduction.

In the nuclear reactor unit 12, a nuclear reaction occurs in the reactor core fuel 42 inside the nuclear reactor 30, generating reaction heat. The generated heat is stored inside the nuclear reactor vessel 40, and the inside reaches a high temperature. In the nuclear reactor unit 12, part of the heat generated in the nuclear reactor 30 is conducted to the heat conduction part 32. The heat conduction part 32 heats a coolant flowing in the coolant circulation unit 16 of the power generation unit 13. As the coolant, carbon dioxide (CO₂) is preferably used.

The nuclear reactor shutdown system 50 is a system for emergency termination of the nuclear reaction of the reactor core fuel 42. The detailed configuration of the nuclear reactor shutdown system 50 of the embodiment is described below.

The coolant circulation unit 16 has a circulation path 34 circulating outside the nuclear reactor vessel 40 and a heat exchanging part 36 circulating inside the nuclear reactor vessel 40. The coolant circulation unit 16 is circulated by the circulation path 34 and the heat exchanging part 36, which form a closed loop. The circulation path 34 is a path circulating the coolant outside the nuclear reactor vessel 40 and connects the turbine 18, the cooler 22, the compressor 24, and the regenerative heat exchanger 26 to each other. The heat exchanging part 36 is inserted into the nuclear reactor vessel 40 and disposed inside. Both ends of the heat exchanging part 36 are exposed outside the nuclear reactor vessel 40 and are connected to the circulation path 34. The heat exchanging part 36 is a conduit through which the coolant circulates and is in contact with the area of the heat conduction part 32 that is not in contact with the reactor core fuel 42. In other words, the heat exchanging part 36 is in contact with the part of the heat conduction part 32 protruding beyond the reactor core fuel 42. The heat exchanging part 36 exchanges heat with the heat conduction part 32 to heat the coolant.

The coolant flowing through the coolant circulation unit 16 is supplied to the heat exchanging part 36. The nuclear power generation system 10 exchanges heat between the heat conduction part 32 and the coolant supplied from the coolant circulation unit 16. A heat exchanger of the present embodiment includes the heat conduction part 32 and the heat exchanging part 36 of the coolant circulation unit 16. The heat exchanger recovers the heat of the heat conduction part 32 by the coolant flowing through the coolant circulation unit 16. In other words, the coolant is heated by the heat conduction part 32. The heat medium heated by the heat exchanging part 36 flows through the turbine 18, the cooler 22, the compressor 24, and the regenerative heat exchanger 26 in this order. The coolant having passed through the regenerative heat exchanger 26 is again supplied to the heat exchanging part 36. The coolant is thus circulated through the coolant circulation unit 16.

Into the turbine 18, the coolant having passed through the heat conduction part 32 flows. The turbine 18 is rotated by the energy of the heated coolant. In other words, the turbine 18 converts the energy of the coolant into rotational energy to absorb energy from the coolant. The generator 20 is coupled to the turbine 18 and rotates in unison with the turbine 18. The generator 20 generates electricity by rotating with the turbine 18.

The cooler 22 cools the coolant having passed through the turbine 18. The cooler 22 is a chiller or, when the coolant is temporarily liquefied, a condenser or the like. The compressor 24 is a pump pressurizing the coolant. The regenerative heat exchanger 26 exchanges heat between the coolant having passed through the turbine 18 and the coolant having passed through the compressor 24. The regenerative heat exchanger 26 heats the coolant having passed through the compressor 24 by the coolant having passed through the turbine 18. In other words, the regenerative heat exchanger 26 exchanges heat between the coolant before being cooled by the cooler 22 and the coolant after being cooled by the cooler 22, recovering heat discarded by the cooler 22 by the coolant before being supplied to the nuclear reactor unit 12.

In the nuclear power generation system 10, the heat generated by the reaction of the nuclear fuel in the nuclear reactor unit 12 is conducted to the coolant in the heat exchanging part 36 by the heat conduction part 32 and heats the coolant flowing through the coolant circulation unit 16 by the heat of the heat conduction part 32. In other words, the coolant absorbs the heat conducted by the heat conduction part 32. The heat generated in the nuclear reactor unit 12 is thereby conducted by the heat conduction part 32 through solid-state heat conduction and is recovered by the coolant. After being compressed by the compressor 24, the coolant is heated and compressed while passing through the heat conduction part 32, and the heated energy rotates the turbine 18. Subsequently, the coolant is cooled to a standard state by the cooler 22 and is again supplied to the compressor 24.

As described above, the nuclear power generation system 10 conducts the heat of the nuclear reactor 30 to the coolant as a medium rotating the turbine 18 by using the heat conduction part 32 conducting heat through solid-state heat conduction.

By using carbon dioxide as the coolant, the nuclear power generation system 10 can prevent contamination of the coolant even when the coolant is circulated inside the nuclear reactor 30. This can reduce the risk of contamination of the medium rotating the turbine 18. In addition, by providing the heat conduction part 32 conducting heat through solid-state heat conduction, a neutron beam can be blocked by the heat conduction part 32.

The nuclear reactor vessel 40 is preferably formed of a material with lower thermal conductivity than that of the heat conduction part 32. This can prevent heat inside the nuclear reactor 30 from being discharged to the outside from parts other than the heat conduction part 32, which is the path for discharging heat to the outside.

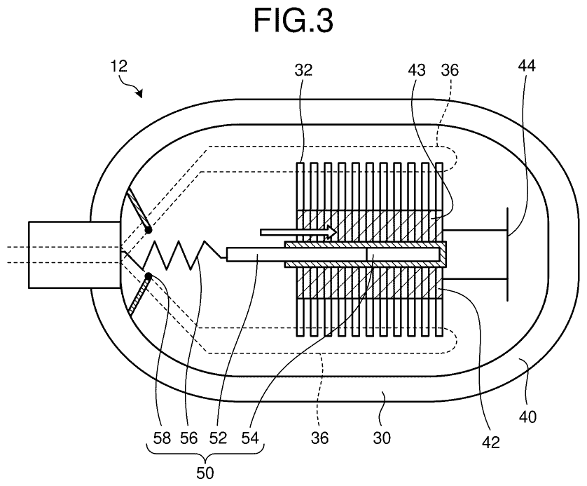

FIG. 2 is a schematic diagram of a schematic configuration of a nuclear reactor unit including the nuclear reactor shutdown system according to the present embodiment. FIG. 3 is a schematic diagram of a state in which the nuclear reactor shutdown system illustrated in FIG. 2 has worked. The nuclear reactor shutdown system 50 includes a neutron absorber 52, a shielded path 54, an elastic member 56, and a braking part 58.

The neutron absorber 52 is a material containing, for example, boron (B), cadmium (Cd), xenon (Xe), or hafnium (Hf) absorbing neutrons. The neutron absorber 52 illustrated in FIG. 2 and FIG. 3 is what is called a control rod in the form of a rod extending in the horizontal direction. As illustrated in FIG. 3, the neutron absorber 52 reduces neutrons absorbed by the nuclear fuel and can inhibit a nuclear reaction or shut down the nuclear reactor 30 by being inserted into a reactor core.

The shielded path 54 is a path passing through the reactor core fuel 42. The shielded path 54 is formed extending on the extension of a direction in which the neutron absorber 52 extends. The shielded path 54 of the embodiment is formed at the center of the reactor core extending in the horizontal direction. One end of the shielded path 54 (on the left in FIG. 2 and FIG. 3) is open to the outside of the reactor core fuel 42. The other end of the shielded path 54 (on the right in FIG. 2 and FIG. 3) is closed. The shielded path 54 enables the neutron absorber 52 to enter from the opening.

The elastic member 56 is disposed across the neutron absorber 52 on the extension of the side in which the shielded path 54 is open. The elastic member 56 is a compression coil spring in the embodiment. In the elastic member 56, one arm part of the compression coil spring is fixed to the nuclear reactor vessel 40, the other arm part thereof is fixed to the neutron absorber 52, and the end closer to the neutron absorber 52 can reciprocate in the axial direction through elastic force. The elastic member 56 is maintained in a compressed state by the braking part 58 during rated operation of the nuclear reactor vessel 40. When the elastic member 56 is in the compressed state, the neutron absorber 52 remains supported only at its tip on the opening of the shielded path 54.

The elastic member 56 is elastically deformable such that the neutron absorber 52 expands in a direction entering the shielded path 54 by being released from the braking part 58. That is, the elastic member 56, by being released from the compressed state, urges the neutron absorber 52 to the direction entering inside from the opening of the shielded path 54. The elastic member 56 is formed of a material with a melting point higher than a threshold temperature so at to be able to maintain its shape even when the elastic member 56 reaches a temperature higher than the temperature during the rated operation of the nuclear reactor vessel 40, that is, when an abnormal operating state occurs and the braking part 58 described below reaches the threshold temperature.

The braking part 58 is disposed so as to maintain the compressed state of the elastic member 56. In the example illustrated in FIG. 2, the braking part 58 includes a plate-like part that is disposed so as to cover a coil part except for the arm part from the end of the elastic member 56 fixed to the neutron absorber 52. The plate-like part melts to open a hole or degenerates to break away at the threshold temperature or higher. The braking part 58 may include, for example, a valve body opening at the threshold temperature or higher. The braking part 58 may be, for example, string-like, connecting both ends of the elastic member 56 in the compressed state.

As illustrated in FIG. 2, the braking part 58, when it is lower than the certain threshold temperature, maintains the state in which the elastic member 56 is compressed. As illustrated in FIG. 3, when reaching or exceeding the threshold temperature, the braking part 58 releases the elastic member 56 from the compressed state. The braking part 58 is formed of, for example, a material melting or degenerating at the threshold temperature or higher. The braking part 58 is formed of a material the melting point of which is the temperature during the rated operation of the nuclear reactor vessel 40 or higher. The braking part 58 is formed of, for example, metal such as brass.

The nuclear reactor shutdown system 50 maintains the temperature of the braking part 58 lower than the threshold temperature during the rated operation of the nuclear reactor 30. In this state, the braking part 58 maintains the compressed state of the elastic member 56, and thus the neutron absorber 52 remains supported only at its tip on the opening of the shielded path 54.

In the nuclear reactor shutdown system 50, if an abnormality occurs in the nuclear reactor 30 and the temperature in the nuclear reactor vessel 40 rises, and thereby the temperature of the braking part 58 reaches or exceeds the threshold temperature, as illustrated in FIG. 3, the end of the elastic member 56 fixed to the neutron absorber 52 is released, and the compressed state is released. When the elastic member 56 is released from the compressed state, the neutron absorber 52 is urged toward the shielded path 54 and enters the inside of the shielded path 54.

The neutron absorber 52 having entered the inside of the shielded path 54, that is, having reached the inside of the reactor core absorbs the neutrons of the reactor core to inhibit the nuclear reaction of the reactor core fuel 42. The neutron absorber 52 having been urged by the elastic member 56 advances further inside the shielded path 54 toward the closed end, and the amount of entry into the inside of the reactor core increases to also increase the absorption amount of the neutrons of the reactor core, thus stopping the nuclear reaction of the reactor core fuel 42.

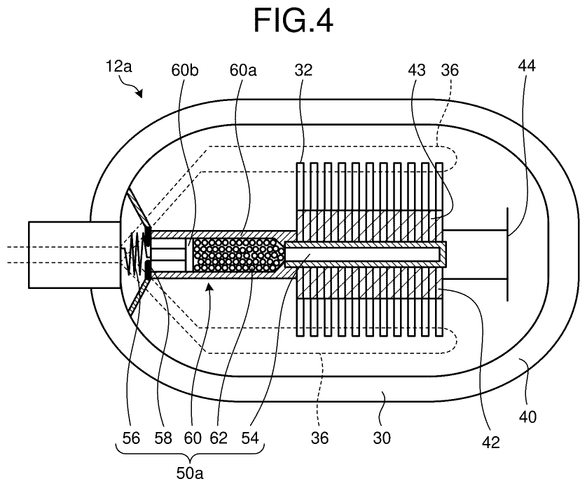

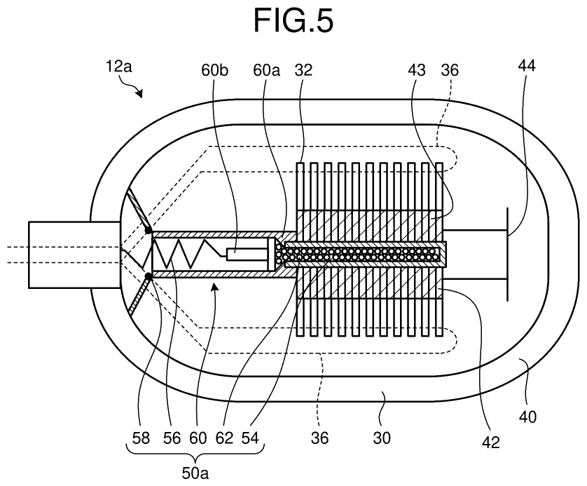

FIG. 4 is a schematic diagram of a nuclear reactor unit including another example of the nuclear reactor shutdown system. FIG. 5 is a schematic diagram of a state in which the nuclear reactor shutdown system illustrated in FIG. 4 has worked. This nuclear reactor shutdown system 50a included in this nuclear reactor unit 12a illustrated in FIG. 4 and FIG. 5 differs from the nuclear reactor shutdown system 50 illustrated in FIG. 2 and FIG. 3 in that it includes a feeding member 60 and a plurality of spherical neutron absorbers 62 instead of the rod-like neutron absorber 52. The following describes the feeding member 60 and the neutron absorbers 62, which are unique components of the nuclear reactor shutdown system 50a, and omits detailed descriptions of the same components as in the nuclear reactor shutdown system 50.

The feeding member 60 is a member configured to feed the neutron absorbers 62 inward from the opening of the shielded path 54 along with the elastic member 56 being released from its compressed state. The feeding member 60 is disposed between the opening side of the shielded path 54 and the elastic member 56. The feeding member 60 has a cylinder 60a and a piston 60b in the embodiment.

The cylinder 60a is disposed on the extension of the opening side of the shielded path 54. At one end of the cylinder 60a (on the left in FIG. 4 and FIG. 5), the braking part 58 is disposed. The other end of the cylinder 60a (on the right in FIG. 4 and FIG. 5) communicates with the shielded path 54 through an opening.

The piston 60b is disposed so as to be able to move axially (in the right-and-left direction in FIG. 4 and FIG. 5) inside the cylinder 60a. The piston 60b is fixed to the elastic member 56 so as to be able to reciprocate in the axial direction through the elastic force of the elastic member 56. The piston 60b is urged toward the shielded path 54 by the elastic member 56 by the elastic member 56 being released from the braking part 58 to be released from its elastic state.

The inside space of the cylinder 60a is separated by the piston 60b into the shielded path 54 side and the elastic member 56 side. As illustrated in FIG. 4, the neutron absorbers 62 are housed on the shielded path 54 side of the inside of the cylinder 60a. Whereas the neutron absorber 52 of the nuclear reactor shutdown system 50 illustrated in FIG. 2 and FIG. 3 is rod-like, the neutron absorbers 62 of the nuclear reactor shutdown system 50a illustrated in FIG. 4 and FIG. 5 are multi-particulate. The neutron absorbers 62 illustrated in FIG. 4 and FIG. 5 are a plurality of solid spheres, but their individual shapes are not limited to a particular shape so long as they can move minutely and independently and may include, for example, an oval or rod-like shape. They are not limited to solids and may include gels, liquids, and gases, but they are preferably solid spheres.

In the nuclear reactor shutdown system 50a, the temperature of the braking part 58 is maintained lower than the threshold temperature during the rated operation of the nuclear reactor 30. In this state, as illustrated in FIG. 2, the braking part 58 maintains the compressed state of the elastic member 56, and thus the piston 60b remains drawn toward the elastic member 56 inside the cylinder 60a, and the neutron absorbers 62 remain kept inside the cylinder 60a.

In the nuclear reactor shutdown system 50a, if an abnormality occurs in the nuclear reactor 30 and the temperature in the nuclear reactor vessel 40 rises, and thereby the temperature of the braking part 58 reaches or exceeds the threshold temperature, as illustrated in FIG. 3, the end of the elastic member 56 fixed to the piston 60b is released, and the compressed state is released. When the elastic member 56 is released from the compressed state, the piston 60b is urged toward the shielded path 54, feeding the neutron absorbers 62 inside the cylinder 60a inward from the opening of the shielded path 54.

The neutron absorbers 62 having entered the inside of the shielded path 54, that is, having reached the inside of the reactor core absorb the neutrons of the reactor core to inhibit the nuclear reaction of the reactor core fuel 42. The shielded path 54 is filled with the neutron absorbers 62 one after another, and the neutron absorbers 62 absorb the neutrons in the reactor core, thereby stopping the nuclear reaction of the reactor core fuel 42.

In the nuclear reactor shutdown system 50a illustrated in FIG. 4 and FIG. 5, the neutron absorbers 62 are solid spheres, and thus the neutron absorbers 62 can roll inside the cylinder 60a. This can prevent the neutron absorbers 62 from clogging at the opening when the neutron absorbers 62 are fed by the piston 60b toward the opening of the shielded path 54 one after another.

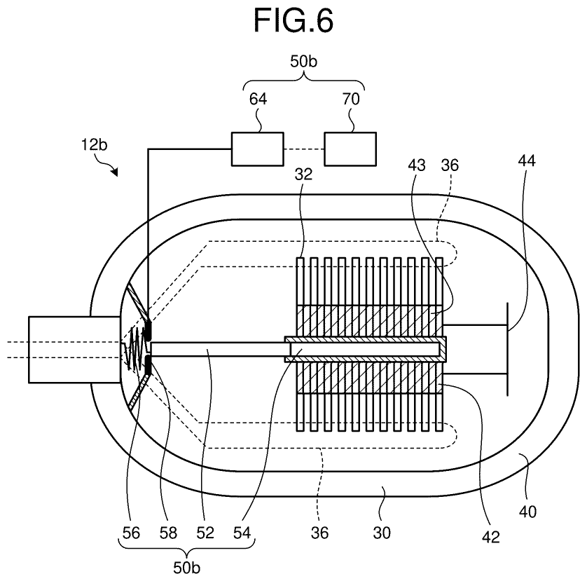

FIG. 6 is a schematic diagram of a nuclear reactor unit including another example of the nuclear reactor shutdown system. This nuclear reactor shutdown system 50b included in this nuclear reactor unit 12b illustrated in FIG. 6 further includes a heating unit 64 and a controller 70 in addition to the components of the nuclear reactor shutdown system 50 illustrated in FIG. 2. The following describes the heating unit 64 and the controller 70, which are unique components of the nuclear reactor shutdown system 50b, and omits detailed descriptions of the same components as in the nuclear reactor shutdown system 50.

The heating unit 64 can heat the braking part 58 up to the threshold temperature or higher based on a control signal received from the controller 70. The configuration and the method of heating of the heating unit 64 are not limited to particular ones. For example, the braking part 58 may be heated by directly energizing it or heated through heat radiation from a heat source that is heated by energization.

The controller 70 sends the control signal for heating the braking part 58 to the heating unit 64. The controller 70 may send the control signal for heating the braking part 58 when a certain operation by an operator is received. When detecting some abnormality, the controller 70 may send the control signal for heating the braking part 58 based on certain criteria. The controller 70 may be included as a partial function of a control system controlling the operation of the nuclear reactor unit 12 or included in conjunction with the nuclear reactor unit 12 or the nuclear power generation system 10, for example, as a partial function of an auxiliary power source system when an abnormality occurs.

### Effects of Embodiment

The nuclear reactor shutdown system 50, 50a, or 50b and the method of nuclear reactor shutdown described in the embodiment are understood, for example, as follows.

The nuclear reactor shutdown system 50, 50a, or 50b according to a first aspect includes the shielded path 54 passing through the reactor core fuel 42 housed in the nuclear reactor vessel 40 in a hermetically sealed manner, one end of the shielded path 54 being open and the other end of the shielded path 54 being closed, the neutron absorber 52 or 62 capable of entering from the opening of the shielded path 54, the elastic member 56 configured to urge the neutron absorber 52 or 62 in a direction entering inside from the opening of the shielded path 54 by being released from a compressed state, and the braking part 58 disposed so as to maintain the compressed state of the elastic member 56 and configured to release the elastic member 56 from the compressed state when the braking part 58 reaches or exceeds a threshold temperature.

The nuclear reactor shutdown system 50, 50a, or 50b according to the first aspect releases the elastic member 56 from the compressed state when the braking part 58 maintaining the compressed state of the elastic member 56 reaches or exceeds the threshold temperature along with a temperature rise in the nuclear reactor vessel 40 in the event of an abnormality. The elastic member 56 keeps the neutron absorber 52 or 62 outside the reactor core fuel 42 in the compressed state and urges it toward the inside of the reactor core fuel 42 when the compressed state is released. That is, when the braking part 58 reaches or exceeds the threshold temperature, the neutron absorber 52 or 62 enters through the reactor core fuel 42 without requiring any special control functions, and thus the nuclear reaction can be passively inhibited to shut down the function safely and quickly in the event of an abnormal temperature rise in the nuclear reactor vessel 40. The direction in which the elastic member 56 urges the neutron absorber 52 or 62 is not limited to a particular direction and can be changed as appropriate, such as the horizontal direction, the vertical direction, or a diagonal direction, in accordance with the shape and internal configuration of the nuclear reactor vessel 40 and the arrangement of the reactor core fuel 42. Thus, the nuclear reactor shutdown system 50, 50a, or 50b according to the first aspect can also be used for small-sized nuclear reactors.

The nuclear reactor shutdown system 50, 50a, or 50b according to a second aspect is provided in the nuclear reactor unit 12 including the nuclear reactor 30 including the reactor core fuel 42 and the nuclear reactor vessel 40 and the heat conduction part 32 disposed inside the nuclear reactor vessel 40 and configured to conduct the heat of the reactor core fuel 42 through solid-state heat conduction. The nuclear reactor shutdown system 50, 50a, or 50b can achieve a configuration in which, when the braking part 58 reaches or exceeds the threshold temperature, the neutron absorber 52 or 62 enters through the reactor core fuel 42 without requiring any special control functions, and can thus also be used for the nuclear reactor unit 12 conducting the heat of the reactor core fuel 42 through solid-state heat conduction.

In the nuclear reactor shutdown system 50, 50a, or 50b according to a third aspect, the braking part 58 is formed of a material melting or degenerating at the threshold temperature or higher. Such a braking part 58 melts to open a hole, ruptures, or degenerates at the threshold temperature or higher to break away from a peripheral part. This can achieve a configuration in which the elastic member 56 is released from the compressed state when the communicating parts 56 and 57 reach or exceed the threshold temperature with a simple configuration.

In the nuclear reactor shutdown system 50 or 50b according to a fourth aspect, the neutron absorber 52 is rod-like, extending in a direction in which the shielded path 54 extends. That is, the neutron absorber 52 is what is called a control rod. The control rod enters through the reactor core fuel 42 when the braking part 58 reaches or exceeds the threshold temperature, and thus a configuration passively inhibiting the nuclear reaction to shut down the function safely and quickly in the event of an abnormal temperature rise in the nuclear reactor vessel 40 can be achieved with a simple configuration.

The nuclear reactor shutdown system 50a according to a fifth aspect includes the feeding member 60 configured to feed the neutron absorbers 62 inward from the opening of the shielded path 54 along with the elastic member 56 being released from the compressed state. That is, the neutron absorbers 62 can be kept outside the reactor core fuel 42 and urged to the inside of the reactor core fuel 42 without a configuration directly connecting the elastic member 56 and the neutron absorbers 62 to each other.

In the nuclear reactor shutdown system 50a according to a sixth aspect, the feeding member 60 has the cylinder 60a having one end in which the braking part 58 is disposed and having another end communicating with the opening of the shielded path 54, and has the piston 60b capable of reciprocating inside the cylinder 60a through the elastic force of the elastic member 56, and the neutron absorbers 62 are housed inside the cylinder 60a placed on the shielded path 54 side with respect to the piston 60b is and is fed inward from the opening of the shielded path 54 by the piston 60b being urged toward the shielded path 54. That is, a configuration in which the neutron absorbers 62 are kept outside the reactor core fuel 42 and urged to the inside of the reactor core fuel 42 can be achieved with a simple configuration without directly connecting the elastic member 56 and the neutron absorbers 62 to each other.

In the nuclear reactor shutdown system 50a according to a seventh aspect, the neutron absorbers 62 are a plurality of solid spheres. The neutron absorbers 60 are not a single mass of material but a plurality of materials that can pass through the opening of the shielded path 54, thus giving flexibility in its overall shape in a state of being housed within the cylinder 60a. That is, the cylinder 60a housing the neutron absorbers 62 has a flexible diameter and can be shortened in the axial direction, enabling it to be used even for small-sized nuclear reactors. The neutron absorbers 62 can roll inside the cylinder 60a, which can prevent the neutron absorbers 62 from clogging at the opening when the neutron absorbers 62 are fed by the piston 60b toward the opening of the shielded path 54 one after another.

The nuclear reactor shutdown system 50b according to an eighth aspect further includes the heating unit 64 capable of heating the braking part 58 up to the threshold temperature or higher and the controller 70 configured to send a control signal for heating the braking part 58 to the heating unit 64. That is, even when the braking part 58 has not risen to the threshold temperature in the event of an abnormality, if a further temperature rise in the nuclear reactor vessel 40 is predicted or another abnormality is detected, the nuclear reaction can be inhibited to shut down the function safely and quickly in an aggressive manner as well.

The method of nuclear reactor shutdown according to a ninth aspect, in the shielded path 54 passing through the reactor core fuel 42 housed in the nuclear reactor vessel 40 in a hermetically sealed manner, one end of the shielded path 54 being open and the other end of the shielded path 54 being closed, the neutron absorber 52 or 62 capable of entering from the opening of the shielded path 54, the elastic member 56 configured to urge the neutron absorber 52 or 62 in a direction entering inside from the opening of the shielded path 54 by being released from a compressed state, and the braking part 58 disposed so as to maintain the compressed state of the elastic member 56 and configured to release the elastic member 56 from the compressed state when the braking part 58 reaches or exceeds a threshold temperature, the method includes causing the neutron absorber 52 or 62 urged by the elastic member 56 to enter inside from the opening of the shielded path 54 by releasing the elastic member 56 from the compressed state when the braking part 58 reaches or exceeds the threshold temperature.

The method of nuclear reactor shutdown according to the ninth aspect releases the elastic member 56 from the compressed state when the braking part 58 maintaining the compressed state of the elastic member 56 reaches or exceeds the threshold temperature along with a temperature rise in the nuclear reactor vessel 40 in the event of an abnormality. The elastic member 56 keeps the neutron absorber 52 or 62 outside the reactor core fuel 42 in the compressed state and urges it toward the inside of the reactor core fuel 42 when the compressed state is released. That is, when the braking part 58 reaches or exceeds the threshold temperature, the neutron absorber 52 or 62 enters through the reactor core fuel 42 without requiring any special control functions, and thus the nuclear reaction can be passively inhibited to shut down the function safely and quickly in the event of an abnormal temperature rise in the nuclear reactor vessel 40. The direction in which the elastic member 56 urges the neutron absorber 52 or 62 is not limited to a particular direction and can be changed as appropriate, such as the horizontal direction, the vertical direction, or a diagonal direction, in accordance with the shape and internal configuration of the nuclear reactor vessel 40 and the arrangement of the reactor core fuel 42. Thus, the method of nuclear reactor shutdown according to the ninth aspect can also be used for small-sized nuclear reactors.

The above has described the embodiment of the present disclosure, but the embodiment is not limited by the descriptions of the embodiment.

### REFERENCE SIGNS LIST

10 Nuclear power generation system
12, 12a, 12b Nuclear reactor unit
13 Power generation unit
14 Heat exchanger
16 Coolant circulation unit
18 Turbine
20 Generator
22 Chiller (cooler)
24 Pump (compressor)
26 Regenerative heat exchanger
30 Nuclear reactor
32 Heat conduction part
34 Circulation path
36 Heat exchanging part
40 Nuclear reactor vessel
42 Reactor core fuel
43 Fuel holding plate
44 Control unit
50, 50a, 50b Nuclear reactor shutdown system
52, 62 Neutron absorber
54 Shielded path
56 Elastic member
58 Braking part
60 Feeding member
60a Cylinder
60b Piston
64 Heating unit
70 Controller

1. A nuclear reactor shutdown system comprising:
a shielded path that passes through a reactor core fuel housed in a nuclear reactor vessel in a hermetically sealed manner, one end of the shielded path having an opening and another end of the shielded path being closed;
a neutron absorber that is allowed to enter from the opening of the shielded path;
an elastic member that is configured to urge the neutron absorber in a direction entering inside from the opening of the shielded path by being released from a compressed state; and
a braking part that is disposed so as to maintain the compressed state of the elastic member and is configured to release the elastic member from the compressed state when the braking part reaches or exceeds a threshold temperature.

2. The nuclear reactor shutdown system according to claim 1, provided in a nuclear reactor unit that comprises:
a nuclear reactor that includes the reactor core fuel and the nuclear reactor vessel; and
a heat conduction part that is disposed inside the nuclear reactor vessel and is configured to conduct heat of the reactor core fuel through solid-state heat conduction.

3. The nuclear reactor shutdown system according to claim 1, wherein the braking part is formed of a material melting or degenerating at the threshold temperature or higher.

4. The nuclear reactor shutdown system according to claim 1, wherein the neutron absorber is rod-like, extending in a direction in which the shielded path extends.

5. The nuclear reactor shutdown system according to claim 1, further comprising a feeding member that is configured to feed the neutron absorber inward from the opening of the shielded path along with the elastic member being released from the compressed state.

6. The nuclear reactor shutdown system according to claim 5, wherein
the feeding member includes a cylinder having one end in which the braking part is disposed and having another end communicating with the opening of the shielded path, and includes a piston that is configured to reciprocate inside the cylinder through elastic force of the elastic member, and
the neutron absorber is housed inside the cylinder placed on a side of the shielded path with respect to the piston is and is fed inward from the opening of the shielded path by the piston being urged toward the shielded path.

7. The nuclear reactor shutdown system according to claim 6, wherein the neutron absorber is a plurality of solid spheres.

8. The nuclear reactor shutdown system according to claim 1, further comprising:
a heating unit that is configured to heat the braking part up to the threshold temperature or higher; and
a controller that is configured to send a control signal for heating the braking part to the heating unit.

9. A method of nuclear reactor shutdown for a system that includes:
a shielded path that passes through a reactor core fuel housed in a nuclear reactor vessel in a hermetically sealed manner, one end of the shielded path having an opening and another end of the shielded path being closed;
a neutron absorber that is allowed to enter from the opening of the shielded path;
an elastic member that is configured to urge the neutron absorber in a direction entering inside from the opening of the shielded path by being released from a compressed state; and
a braking part that is disposed so as to maintain the compressed state of the elastic member and is configured to release the elastic member from the compressed state when the braking part reaches or exceeds a threshold temperature, the method comprising
causing the neutron absorber urged by the elastic member to enter inside from the opening of the shielded path by releasing the elastic member from the compressed state when the braking part reaches or exceeds the threshold temperature.
